(19) United States
(12) Patent Application Publication
(10) Pub. No.: US 2024/0262219 A1
(43) Pub. Date: Aug. 8, 2024

(54) FLOOR ASSEMBLY FOR AN INDUCTIVE CHARGING DEVICE

(71) Applicant: MAHLE International GmbH, Stuttgart (DE)

(72) Inventor: Mike Boettigheimer, Kornwestheim (DE)

(21) Appl. No.: 18/568,798

(22) PCT Filed: May 24, 2022
(86) PCT No.: PCT/EP2022/064063

§ 371 Date: Dec. 8, 2023

(30) Foreign Application Priority Data
Jun. 11, 2021 (DE) 10 2021 205 981.3

(51) Int. Cl. B60L 53/12; B60L 53/302

(52) U.S. Cl. CPC B60L 53/12; B60L 53/302

(57) ABSTRACT

A floor assembly for an inductive charging device for inductive charging of a motor vehicle parked on an underground is disclosed. The floor assembly includes a base plate, at least one flat coil spaced from the base plate in a spacing direction, a core arrangement for guiding a magnetic flux, and a holder for holding the core arrangement. At least one support is disposed between a holding structure of the holder and the base plate. The at least one support is structured as a heat-conducting element made of a material with a thermal conductivity of A>5 W/(m-K) and is arranged transversely to the spacing direction.

### CROSS-REFERENCE TO RELATED APPLICATIONS

This application claims priority to International Patent Application No. PCT/EP2022/064063 filed May 24, 2022, which also claims priority to German Patent Application DE 10 2021 205 981.3 filed Jun. 11, 2021, the contents of each of which is hereby incorporated by reference in its entirety.

### TECHNICAL FIELD

The present invention relates to a floor assembly for an inductive charging device for inductive charging of a motor vehicle.

### BACKGROUND

In the case of at least partially electrically powered vehicles, regular charging of the vehicle's electrical energy storage system is necessary. In principle, a direct electrical connection can be established between the vehicle and an external electrical energy source, such as a power connection. However, this requires manual action by a user.

It is also known to inductively charge the motor vehicle, i.e., in particular the electrical energy storage device, which can be an accumulator, for example. Corresponding charging devices for this purpose each have an assembly in the vehicle and outside it. The assembly outside the vehicle contains a primary coil which interacts inductively with a secondary coil of the assembly in the vehicle in order to charge the energy storage unit. The assembly in the vehicle is also referred to as a vehicle assembly. The assembly outside the vehicle is usually located underneath the vehicle during operation and is referred to as the floor assembly.

When the charging device is in operation, the vehicle to be charged is located on an underground above the floor assembly. The floor assembly can be arranged on or in the underground. In any case, the floor assembly must be designed in such a way that it can carry the load of the vehicle to be charged with the charging device, if necessary. This is particularly important because motor vehicles drive on and off the underground for charging and can transfer corresponding loads to the floor assembly in this context, especially when maneuvering, even if the motor vehicle does not transfer any direct load to the floor assembly during the charging process itself in the intended use case. This means that, ideally, the vehicle does not drive directly over the floor assembly, but this can certainly happen, for example when maneuvering. It is therefore necessary to design the floor assembly for such loads.

During operation of the charging device, heat can be generated in the respective assembly, in particular in the floor assembly, especially due to the charging power to be provided. In the case of the floor assembly, this heat can lead to an undesirable rise in temperature of the floor assembly and/or neighboring objects and thus also to derating (reduction in charging power due to excessive heat in the system) or failure of the system during charging.

The present invention therefore deals with the problem of specifying an improved or at least different embodiment for a floor assembly for an inductive charging device of the type mentioned at the beginning, which is characterized in particular by the permanent achievement of the rated power in as many operating points as possible (including high outside temperature, high humidity, high current in the system.

According to the invention, this problem is solved by the subject matter of the independent claim(s). Advantageous embodiments are the subject of the dependent claims.

### SUMMARY

The present invention is based on the general idea of improving power transmission when charging, in particular of an electric vehicle, by means of a floor assembly according to the invention with a base plate and a core arrangement supported above it via at least one support with, for example, ferrite plates and a flat coil, in that the base plate is used in particular as a cooling plate and the at least one support is designed as a heat-conducting element in order to improve heat dissipation from, for example, the flat coil or the core arrangement via the at least one support to the base plate and thus heat dissipation or cooling of the flat coil, the core arrangement with, for example, ferrite plates and the base plate, whereby a higher current or a higher charging power can be achieved with the same conductor cross-section or the same current or the same charging power can be achieved with a smaller conductor cross-section. In order not to influence a magnetic field of the flat coil at all or only marginally, the at least one support is arranged transverse to the spacing direction within a middle area of an associated core body of the core arrangement. The middle area is thereby limited by, for example, 80% of a diameter of the individual core bodies in the longitudinal direction and width direction, preferably 70% of the diameter of the individual core bodies in the longitudinal direction and width direction, particularly preferably 50% of the diameter of the individual core bodies in the longitudinal direction and width direction and very particularly preferably 30% of the diameter of the individual core bodies in the longitudinal direction and width direction. The core arrangement has at least one such core body, which extends transversely to the spacing direction in the shape of a plate and has a middle area essentially in the middle and an edge area surrounding it at the edge. In the middle area of the respective core body, for example a ferrite plate, the magnetic flux density generated there by the current flowing in the conductor of the flat coil is sufficiently low, so that an arrangement of the heat-conducting support in this area, even if it is made of metal, is not critical with regard to the impairment of the magnetic flux density. With the floor assembly according to the invention, it is thus possible to operate it with a comparatively high charging power, while at the same time avoiding undesirable heating, in particular overheating, which would have to reduce the charging power. The floor assembly according to the invention for an inductive charging device for inductive charging of a motor vehicle parked on an underground, for example an electric vehicle, thus has in detail the base plate, which is designed in particular as a cooling plate and extends transversely to the spacing direction in the form of a plate. The spacing direction is the surface normal of the base plate and is usually perpendicular when installed. In addition, the floor assembly according to the invention has at least one flat coil which is designed as a primary coil or field coil and which has a conductor which is wound in a spiral shape in particular and at the same time is spaced apart from the base plate in the spacing direction. Also provided is the core arrangement for guiding a magnetic flux, which is spaced apart from the base plate and the flat coil and arranged between the base plate and the flat coil. The core arrangement has at least one core body, which has the middle area and the edge area surrounding it. In addition, the floor assembly according to the invention has a holder for holding the core arrangement, the holder having a holding structure which is spaced apart from the base plate in the spacing direction and which positions the individual core bodies transversely to the spacing direction and in the spacing direction. A lower cavity is formed between the holding structure and the base plate, in which the at least one support is arranged, so that this at least one support preferably extends through the lower cavity in the spacing direction. The holder and thus the core assembly is supported on the base plate via the at least one support. The at least one support is now designed as a heat-conducting element made of a material with a thermal conductivity of λ>5 W/(m-K) and at the same time arranged transversely to the spacing direction within the middle area of an associated core body, for example a ferrite plate. Seen in the spacing direction, the support therefore lies within the middle area, which spans in a plane transverse to the spacing direction. The support, designed as a heat-conducting element, connects the core arrangement and the base plate in a heat-transferring manner. The support according to the invention serves to support the core arrangement or the flat coil arranged thereon and at the same time to control its temperature by connecting the flat coil or the core arrangement and its core body to the base plate in a heat-transferring manner. If the core arrangement thus heats up during operation of the floor assembly according to the invention, heat can be dissipated via the at least one support into the base plate, which is designed in particular as a cooling plate, whereby uniform cooling of the core arrangement and the flat coil is made possible with several such supports, whereby the same charging power can be achieved with a smaller cross-section of the conductor of the flat coil or a higher charging power can be achieved with the same cross-section of the conductor of the flat coil. By arranging the respective support in accordance with the invention at a distance below the middle area of the associated core body, for example the associated ferrite plate, the support can also be positioned in relation to the associated core body in an area in which the magnetic flux density is sufficiently low so that eddy current losses or hysteresis losses cannot occur there when metallic materials are used for the support. This also prevents field distortion and thus a different operating behavior of the coil system as well as additional heating of the metallic material directly by the magnetic field. Such a middle area in the flat coil designed as a primary coil is, for example, explicitly in the middle of the associated ferrite plate or the associated core body, wherein a distance to the edge of the core body, for example the ferrite plate, can differ depending on the orientation of the primary direction of the magnetic field to be expected. This means that the edge area of each core body, for example each ferrite plate, can be defined individually depending on the shape of the expected magnetic flux direction or magnetic flux density. The individual core bodies, for example the ferrite plates, are spaced apart from each other transversely to the spacing direction, wherein the magnetic flux density is significantly greater both between the individual core bodies and in their edge area than in the respective middle area of the core body. A thermal conductivity λ of λ>5 W/(m-K) ensures the heat transfer required for sufficient cooling of the core arrangement or the core body and the flat coil, wherein a wide variety of materials can be used, as described in the following paragraphs.

In an advantageous further development of the solution according to the invention, the at least one support has a material with a thermal conductivity of λ>10 W/(m·K), in particular a thermal conductivity of λ>100 W/(m·K). The material for the respective supports can therefore be, for example, iron with a thermal conductivity λ of approx. 80 W/(m·K), but also aluminum with a thermal conductivity λ of 235 W/(m·K) or steel/stainless steel. In purely theoretical terms, it is even conceivable that plastics with corresponding metal particles are used, which can provide the heat transfer or thermal conductivity of λ>5 W/(m·K) required for the desired cooling effect. Due to the arrangement of the supports transverse to the spacing direction within the middle area of the respective associated core body according to the invention, even the use of metals is not critical since the magnetic flux density is sufficiently low in this middle area of the respective core body, for example the respective ferrite plate, so that metallic bodies placed there do not cause any eddy current losses or any impairment of the magnetic field. With the positioning according to the invention, it is thus possible for the first time to use metallic supports for heat dissipation and thus for heat dissipation or cooling of the flat coil or the core arrangement without or with only marginal influence on the magnetic field.

In an advantageous further development, the base plate has at least one cooling channel for a coolant. This enables active cooling of the base plate during operation, wherein the heat-conducting supports also cool the core arrangement or the core body and the flat coil arranged above it in the installed state. In addition, the actively cooled base plate in turn cools the air inside the lower cavity, making it possible to cool the electronics located there as well as the core arrangement or core body located above the lower cavity.

The base plate itself is advantageously made of a metal or metal alloy, such as aluminum, to improve heat transfer between the coolant, base plate, air, and supports. The spaced arrangement of the base plate relative to the flat coil and the core arrangement also minimizes or at least reduces electromagnetic interaction between the base plate and the flat coil and the core arrangement. The distance between the base plate and the core arrangement in the spacing direction can be between several millimeters and several centimeters. By manufacturing the base plate from metal or a metal alloy, the floor assembly is also magnetically or electromagnetically shielded from the underground below.

In an advantageous further development of the solution according to the invention, the at least one support is at least partially made of metal, in particular aluminum. Alternatively, it is also conceivable that the at least one support is partially made of graphite or ceramic, in particular aluminum nitride or aluminum silicide. Graphite has a thermal conductivity λ of 15 to 20 W/(m·K), while an aluminum nitride ceramic can even have a conductivity λ of 180 W/(m·K). The use of such aluminum nitride ceramics in particular is of great interest where a lot of heat has to be dissipated, but where a material may not be electrically conductive under certain circumstances.

In a further advantageous embodiment of the floor assembly according to the invention, at least one support is tubular. Theoretically, of course, it is also conceivable to have a solid design for the respective support or to provide several hollow areas running parallel to each other in the spacing direction. This results in reduced material usage and therefore lower costs. This also makes soldering easier due to better accessibility.

A distributor plate (heat spreader) is conveniently arranged between the at least one support and the core arrangement or the retaining structure. Such a distributor plate can ensure improved heat transfer and thus improved cooling of the core arrangement, wherein it is of course clear that the distributor plate, if it is metallic, is also arranged within the middle area, in particular in order to at least minimize any influence on the magnetic field and thus the generation of eddy current losses.

In a particularly advantageous embodiment of the floor assembly according to the invention, the distribution plate is connected to the core assembly via an adhesive layer with a thermal conductivity of λ>0.8 W/(m·K) and/or a shear modulus of G<10 MPa to the core assembly. As the adhesive layer, for example an adhesive layer, is extremely thin, a reduced thermal conductivity λ of λ>0.8 W/(m-K) is sufficient. In order to also be able to compensate for different thermal expansion coefficients between the core bodies, for example a ferrite plate, and the distributor plate, it is advantageous to provide the adhesive layer or generally the adhesive layer with a shear modulus G<10 MPa.

Conveniently, the floor assembly has a cover plate on the side of the flat coil facing away from the base plate and at a distance from it, with an upper cavity being formed between the holding structure and the cover plate. In addition, at least one passage can be provided that fluidically connects the lower cavity with the upper cavity. This makes it possible to direct the air cooled via the base plate, which is designed in particular as a cooling plate in the lower cavity, into the upper cavity via the passage, whereby the flat coil, which is preferably open towards the upper cavity, can be effectively cooled. With the upper and lower cavities and the at least one passage, cooling of the core arrangement and the flat coil is thus possible on both sides. The cover plate can be supported by corresponding support bodies on the flat coil or a coil winding carrier of the flat coil, wherein the support bodies penetrate the upper cavity essentially in the spacing direction between the flat coil and the cover plate.

Other important features and advantages of the invention can be seen from the dependent claims, from the drawings, and from the associated description of the figure based on the drawings.

It is understood that the above-mentioned features and those yet to be explained below can be used not only in the combination indicated in each case, but also in other combinations or on their own, without deviating from the scope of the present invention.

### BRIEF DESCRIPTION OF THE DRAWINGS

Preferred exemplary embodiments of the invention are shown in the drawings by way of example and will be explained in more detail in the following description, wherein identical reference signs refer to identical or similar or functionally identical elements.

It shows, depending on the schematic,

FIG. 1 a section through a floor assembly of an inductive charging device according to the invention,

FIG. 2 is a highly simplified illustration of the inductive charging device with the floor assembly and a motor vehicle,

FIG. 3 a view from below of the core arrangement of the floor assembly,

FIG. 4 a view from above of the core arrangement,

FIG. 5 a section through the floor assembly in the area of a support,

FIG. 6 a section through a support of the holder,

FIG. 7 a sectional view of the floor assembly according to the invention in the area of the supports,

FIG. 8 a detailed sectional view in the area of a connection of a support to the core arrangement.

### DETAILED DESCRIPTION

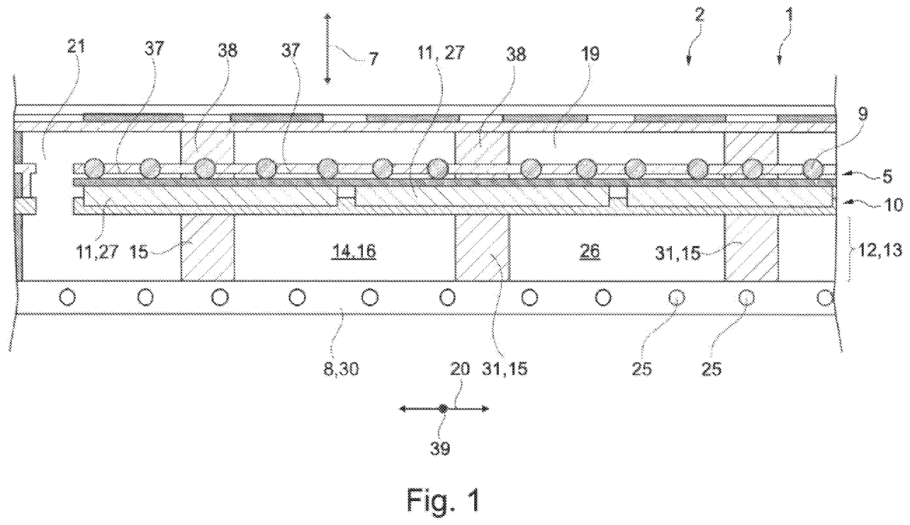

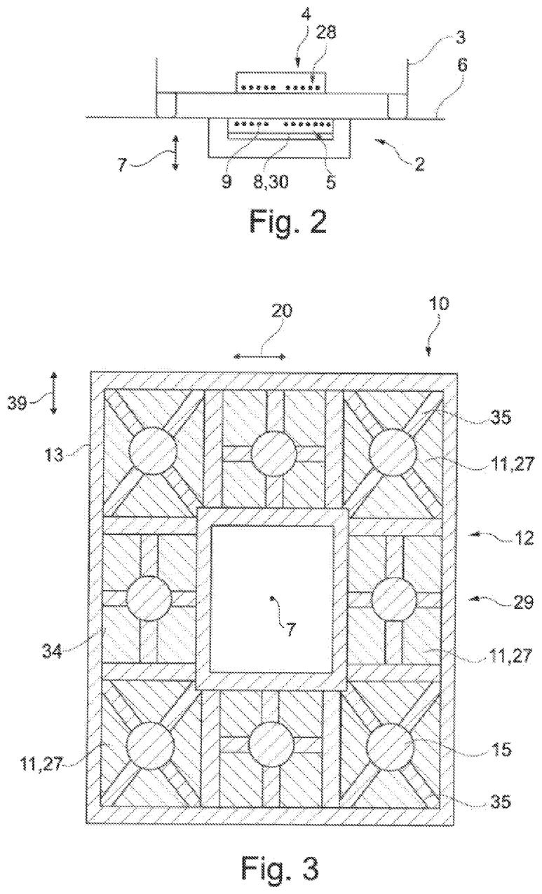

A floor assembly 1 according to the invention, as shown for example in FIGS. 1 through 8, is used in a charging device 2 shown in FIG. 2 for inductive charging of a motor vehicle 3. For this purpose, the floor assembly 1 interacts with an associated assembly 4 of the motor vehicle 3, for example a secondary coil 28. The interaction takes place in particular through a flat coil 5 of the floor assembly 1, which serves as the primary coil of the charging device 2, and the secondary coil 28 of the assembly 4 of the motor vehicle 3. The motor vehicle 3 is parked on an underground 6 for inductive charging using the charging device 2. In the exemplary embodiment shown, the floor assembly 1 is recessed into the underground 6, but can also be arranged on top of it.

The floor assembly 1 has a base plate 8 that is designed in particular as a cooling plate 30. The spacing direction 7 runs parallel to a normal of the underground 6 and in particular along the perpendicular direction. As shown in FIGS. 1, 7 and 8, the flat coil 5 is arranged on the side of the base plate 8 facing away from the underground 6 in the spacing direction 7 and is spaced from the base plate 8 in the spacing direction 7. The flat coil 5 comprises a spirally wound conductor 9. The floor assembly 1 further comprises a core arrangement 10 with at least one core body 11. The core arrangement 10 is arranged on the side of the base plate 8 facing away from the underground 6 and at a distance from the base plate 8 in the spacing direction 7. In addition, the core arrangement 10 is spaced apart from the flat coil 5 in the spacing direction 7. Here, the core arrangement 10 with the at least one core body 11 is arranged between the base plate 8 and the flat coil 5. The core arrangement 10, in particular the at least one core body 11, is held in the floor assembly 1 by means of a holder 12 and supported on the base plate 8. For this purpose, the holder 12 has a retaining structure 13 spaced apart from the base plate 8 in the spacing direction 7, wherein the at least one core body 11 is arranged on the side of the retaining structure 13 facing away from the base plate 8 and is positioned by the retaining structure 13 in a plane extending transversely to the spacing direction 7. The core body 11, which in principle can also be designed as a ferrite plate 27, has a middle area 18 and at least one edge area 22. A lower cavity 14 is arranged between the holding structure 13 and the base plate 8, through which an air flow path 26 can pass and/or in which at least one electronic component is arranged. The holder 12 also has at least one support 15 between the holding structure 13 and the base plate 8, which extends through the lower cavity 14 in the spacing direction 7. At least one of these supports 15 is a heat-conducting element 31 made of a material with a thermal conductivity λ of λ>5 W/(m·K) and is arranged transversely to the spacing direction 7 within the middle area 18 of an associated core body 11 and connects the core arrangement 11 and the base plate 8 in a heat-transferring manner.

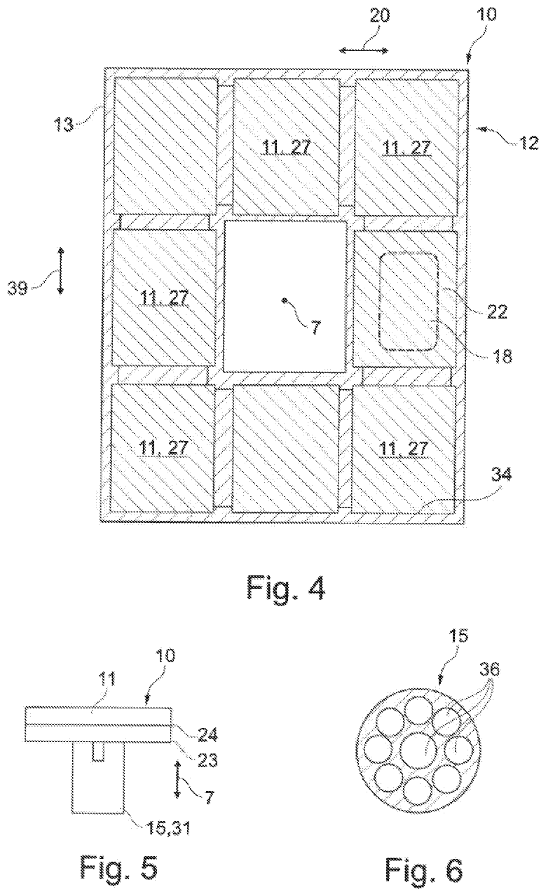

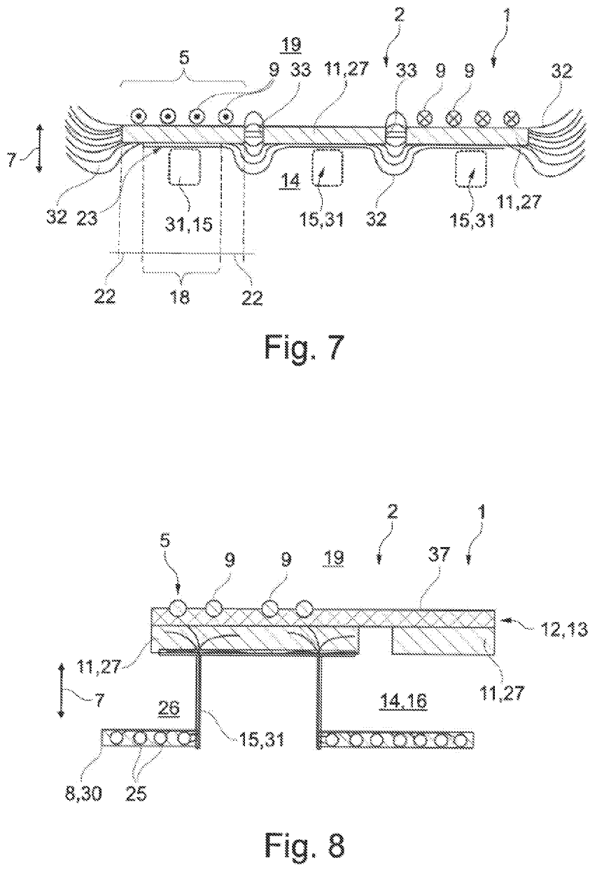

This offers the great advantage that both the core arrangement 10, the flat coil 5 with its conductor 9 and the core bodies 11, for example the ferrite plates 27, can be connected to the base plate 8, which is designed in particular as a cooling plate 30, in a heat-transferring manner via the supports 15, which are designed as heat-conducting elements 31, and can be effectively cooled via them. The arrangement of the supports 15 in the associated middle area 18 of the associated core body 11, viewed transversely to the spacing direction 7 and in the spacing direction 7, also minimizes any influence on the magnetic field generated by the flat coil 5 and in particular on a magnetic flux density, so that even metallic materials can be considered for the supports 15 designed as heat-conducting elements 31 according to the invention. According to FIG. 7, the magnetic field lines are designated by the reference sign 32, which clearly shows that in the area of the supports 15, the magnetic field lines 32 run directly on or in the core body 11 and are therefore not disturbed even with a metallic support 15, which means that no additional eddy currents or hysteresis losses occur in the respective support 15. The respective edge area 22 is different in size in different directions and also with regard to different orientations of the core bodies 11, wherein it can be seen that the magnetic field lines 32 already rum shortly next to a lateral edge 33 of the core body 11, for example the ferrite plate 27, in or close to the core body 11 and the magnetic field thus decreases sharply, so that the support 15 does not necessarily have to be arranged centrally transverse to the spacing direction 7 on the respective core body 11, but the middle area 18 has a certain size (see FIG. 4) and thus allows an individual displacement of the support 15.

In particular, the at least one support 15 extends in the spacing direction 7 up to the base plate 8 and rests on the base plate 8 (see FIGS. 1, 5 and 7) or penetrates it (see FIG. 8). The local support provided by the at least one support 15 results in a corresponding local transmission of the mechanical load exerted on the core arrangement 10, in particular by the motor vehicle 3. This local load transfer leads to a reduction in the load on the at least one core body 11 caused by the load transfer. In this way, an increased mechanical stability of the floor assembly 1 and/or an increased service life is achieved. The support 15 only partially fills the lower cavity 14 so that a flow space 16 remains for a fluid, in the exemplary embodiments shown for air, whereby the core arrangement 10 transfers heat to the base plate 8 via the air, so that cooling of the core arrangement 11 and the flat coil 5 can be improved and consequently the efficiency of the floor assembly 1 can be increased. It is therefore also possible to operate the floor assembly 1 with high power levels, particularly several kW, and consequently to charge the vehicle 3 to be charged more quickly or not to cause derating at any operating point.

In the exemplary embodiments shown, the floor assembly 1 has a cover plate 17. The flat coil 5, the core arrangement 11, and the holder 12 are arranged between the base plate 8 and the cover plate 17. The cover plate 17 is spaced from the flat coil 5 in the spacing direction 7, so that there is an upper cavity 19 between the cover plate 17 and the flat coil 5. In the exemplary embodiments shown, the lower cavity 14 and the upper cavity 19 are fluidically connected to each other via two opposite passages 21 arranged outside the core arrangement 10 in a width direction 20 running transverse to the spacing direction 7. In the exemplary embodiments shown, the base plate 8 is designed as a cooling plate 30, through which cooling channels 25 for a coolant run. The coolant actively cools the base plate 8 during operation. The actively cooled base plate 8 cools the core assembly 10 and the flat coil 5 via the supports 15 and also the air and consequently the flat coil 5 and the core assembly 10 via the air. The base plate 8 is advantageously made of a metal or a metal alloy, in particular aluminum, in order to improve the heat transfer between the coolant, base plate 8 and air. The spaced arrangement of the base plate 8 relative to the flat coil 5 and core arrangement 10 minimizes or at least reduces magnetic or electromagnetic interaction of the base plate 8 with the flat coil 5 and the core arrangement 10. The distance between the base plate 8 and the core arrangement 10 in the spacing direction 7 can be between several millimeters and several centimeters. By manufacturing the base plate 8 from a metal or metal alloy, the floor assembly 1 is also magnetically or electromagnetically shielded.

FIG. 3 shows a view from below of the core arrangement 10 with retaining structure 13. Only the holder 12 and the core arrangement 10 as well as the core bodies 11, for example the ferrite plates 27, can be seen in FIG. 3. FIG. 4 shows a top view of the core assembly 10, showing the core body 11 and the holder 12. FIG. 5 shows a section through the floor assembly 1 in the area of a support 15.

As can be seen in particular from FIGS. 3 and 5, the floor assembly 1 of the exemplary embodiment shown has, by way of example only, eight core bodies 11, which are rectangular and, by way of example, identical. The respective core body 11 is plate-shaped and extends plate-shaped in the width direction 20 as well as in a longitudinal direction 39 running transverse to the width direction 20 and transverse to the spacing direction 7. The respective core body 11 is advantageously a ferrite plate 27 or a ferrite tile.

The core body 11 can be made of a soft magnetic material, in particular a soft magnetic ferrite.

Conveniently, a distributor plate 23 is arranged between the at least one support 15 and the core arrangement 10 or the retaining structure 13. Such a distributor plate 23 can ensure improved heat transfer and thus improved cooling of the core arrangement 10, wherein it is of course clear that the distributor plate 23 is also preferably arranged within the middle area 18, in particular in order to at least minimize an influence on the magnetic field and thus the generation of eddy current losses.

The manifold plate 23 can also be bonded to the core assembly 10 via an adhesive layer 24 with a thermal conductivity of λ>0.8 W/(m·K) and/or a shear modulus of G<10 MPa to the core arrangement 10. Since the adhesive layer 24, for example an adhesive layer, is extremely thin, a reduced thermal conductivity λ of λ>0.8 W/(m·K) is also sufficient here. Furthermore, in order to be able to compensate for different thermal expansion coefficients between the core bodies 11, for example a ferrite plate 27 and the distributor plate 23, it is advantageous to provide the adhesive layer or generally the adhesive layer 24 with a shear modulus G<10 MPa.

As can be seen in particular from FIGS. 1 and 3 and 7, the holder 12 of the embodiments shown has at least two supports 15 spaced apart from one another. The supports 15 have a columnar design and are particularly cylindrical in shape. In the exemplary embodiments shown, at least one of the supports 15 is arranged centrally of the associated core body 11 with respect to an associated core body 11, that is, centrally in the width direction 20 and in the longitudinal direction 39. Seen in the spacing direction 7 within the middle area 18. In the exemplary embodiments shown, a single such support 15 is also assigned to the respective core body 11, so that the holder 12 has a total of eight supports 15 corresponding to the number of core bodies 11. The respective core body 11 preferably rests on the associated support 15. As can be seen in particular in FIG. 3, the respective support 15 is smaller in cross-section than the associated core body 11. In the exemplary embodiments shown, the supports 15 are also identically designed in accordance with the identical design of the core bodies 11. Due to the preferably central arrangement of the support 15 selected in the middle area 18, a central and locally limited mechanical load transfer from the respective core body 11 to the support 15 takes place, so that corresponding bending stresses and tensile stresses on the core body 11 can be better compensated.

As can be seen in particular from FIG. 3, the retaining structure 13 for the respective core body 11 has an opening 34, which fluidically connects the underside 29 of the core body 11 to the lower cavity 14. Thus, the air in the lower cavity 14, in particular the air flowing through the lower cavity 14, is in direct contact with the underside 29 and can improve the cooling of the core body 11. As can also be seen in particular from FIG. 3, the holder 12 for the respective opening 34 has at least one associated strut 35 for stiffening and/or mechanically stabilizing the holding structure 13 in the area of the opening 34 and the lining for the support 15. In the embodiments shown, at least two such struts 35 are provided for the respective opening 34, which are spaced apart from one another. The respective strut 35 extends transversely to the spacing direction 7. In FIG. 3, purely as an example, four struts 35 are provided for seven of the total of eight openings 34 and two struts 35 are provided for one of the openings 34. In the exemplary embodiments shown, the struts 35 of the respective opening 34 protrude from the support 15 associated with the corresponding core arrangement 10. In addition to the improved mechanical stability of the retaining structure 13, the struts 35 ensure turbulence of the air flowing through the lower cavity 14 and thus improved cooling of the core bodies 11.

The respective support 15 can in principle be solid. As can be seen from FIG. 6, at least one of the supports 15 can also have at least one hollow area 36 extending in the spacing direction 7, wherein in FIG. 6 a central hollow area 36 and further hollow area 36 surrounding it are shown purely by way of example, so that a total of nine hollow areas 36 are provided.

In the exemplary embodiments shown, as can be seen in FIGS. 1, 7, and 8, the conductor 9 is accommodated in a plate-shaped flat coil winding carrier 37. The flat coil winding carrier 37 is arranged on the side of the core arrangement 10 facing away from the base plate 8. Here, the flat coil winding carrier 37 is at least partially open on the side facing the cover plate 17, so that the conductor 9 of the flat coil 5 is fluidically connected to the upper cavity 19. This means that the flat coil 5 is in contact with the air in the upper cavity 19, which results in improved cooling of the flat coil 5.

As can also be seen from FIG. 1, in the exemplary embodiments shown at least one local support body 38 extends in the spacing direction 7 between the cover plate 17 and the flat coil winding carrier 37. In the exemplary embodiments shown, several support bodies 38 are provided, which run in the spacing direction 7 and are arranged at a distance from one another. The support bodies 38 therefore extend parallel to the supports 15. As can also be seen from FIG. 1, the support bodies 38 are identical in the embodiments shown. The support bodies 38 serve in particular to transfer the load from the cover plate 17 into the flat coil winding carrier 37 and thus via the flat coil winding carrier 37, the core arrangement 10, and the core bodies 11 into the supports 15. In the embodiments shown, the respective support 15 is assigned such a support body 38, which follows the support 15 in the spacing direction 7, in particular runs parallel, for example coaxially, to the support 15, so that the load is transferred as directly as possible from the respective support body 38 to the associated support 15. In the exemplary embodiments shown, the support bodies 38 are part of the flat coil winding carrier 37.

1. A floor assembly for an inductive charging device for inductive charging of a motor vehicle parked on an underground, comprising:
a base plate that extends transversely to a spacer in the shape of a plate,
at least one flat coil, which has a conductor and is spaced from the base plate in a spacing direction,
a core arrangement for guiding a magnetic flux, which is spaced apart from the base plate and the at least one flat coil in the spacing direction and is arranged between the base plate and the conductor,
wherein the core arrangement has at least one core body which extends transversely to the spacing direction in the form of a plate and has a middle area and at least one edge area,
holder for holding the core arrangement,
wherein the holder has a holding structure which is spaced apart from the base plate in the spacing direction and which positions the at least one core body,
wherein a lower cavity is formed between the holding structure and the base plate,
wherein the holder has at least one support between the holding structure and the base plate, the at least one support extends through the lower cavity in the spacing direction, and
wherein the at least one support is structured as a heat-conducting element made of a material with a thermal conductivity of A>5 W/(m-K) and is arranged transversely to the spacing direction within a middle area of an associated core body and connects the core arrangement and the base plate in a heat-transferring manner.

2. The floor assembly according to claim 1, wherein the at least one support is made of a material with a thermal conductivity λ>10 W/(m·K).

3. The floor assembly according to claim 1, wherein the base plate has at least one cooling channel for a coolant.

4. The floor assembly according to claim 1, wherein the at least one support is at least partially made of metal.

5. The floor assembly according to claim 1, wherein the at least one support is at least partially composed of graphite or ceramic.

6. The floor assembly according to claim 1, wherein the at least one support is tubular or solid.

7. The floor assembly according to claim 1, wherein at least one of the following components is made of ferrite or comprises ferrite; the core arrangement, the holder and/or the holding structure.

8. The floor assembly according to claim 1, wherein the base plate is at least partially made composed of aluminum.

9. The floor assembly according to claim 1, further comprising a distributor plate arranged between the at least one support and the core arrangement.

10. The floor assembly according to claim 9, wherein the distributor plate is connected to the core arrangement via an adhesive layer with a thermal conductivity of λ>0.8 W/(m·K) and/or a shear modulus of G<10 MPa.

11. The floor assembly according to claim 1, wherein an air flow path leads through the lower cavity and/or in which at least one electronic component is arranged.

12. The floor assembly according to claim 1, wherein:
a cover plate is provided on a side of the flat coil facing away from the base plate and at a distance from the base plate in the spacing direction, and
an upper cavity is provided between the holding structure and the cover plate.

13. The floor assembly according to claim 12, further comprising at least one passage that fluidically connects the lower cavity to the upper cavity.

14. The floor assembly according to claim 1, wherein the at least one support is composed of a material having a thermal conductivity λ>100 W/(m·K).

15. The floor assembly according to claim 1, wherein the at least one support is at least partially composed of aluminum.

16. The floor assembly according to claim 1, wherein the at least one support is at least partially composed of aluminum nitride.

17. The floor assembly according to claim 1, wherein the at least one support is at least partially composed of aluminum silicide.

18. An inductive charging device, comprising: a floor assembly, the floor assembly including:
a cooling plate that extends transversely to a spacer in the shape of a plate,
at least one flat coil having a conductor and is spaced from the cooling plate in a spacing direction,
a core arrangement for guiding a magnetic flux, which is spaced apart from the cooling plate and the at least one flat coil in the spacing direction and is arranged between the cooling plate and the conductor,
wherein the core arrangement has at least one core body which extends transversely to the spacing direction in the form of a plate and has a middle area and at least one edge area,
a holder for holding the core arrangement,
wherein the holder has a holding structure which is spaced apart from the cooling plate in the spacing direction and which positions the at least one core body,
wherein a lower cavity is formed between the holding structure and the cooling plate,
at least one support disposed between the holding structure and the cooling plate, the at least one support extends through the lower cavity in the spacing direction, and
wherein the at least one support is structured as a heat-conducting element made of a material with a thermal conductivity of A>5 W/(m-K), is arranged transversely to the spacing direction within a middle area of an associated core body and connects the core arrangement and the cooling plate in a heat-transferring manner.

19. The inductive charging device according to claim 18, wherein the at least one support is composed of a material with a thermal conductivity λ>10 W/(m·K).

20. The inductive charging device according to claim 18, wherein the cooling plate has at least one cooling channel for a coolant.
